(19) United States
(12) Patent Application Publication
(10) Pub. No.: US 2026/0088667 A1
(43) Pub. Date: Mar. 26, 2026

(54) ROTOR WITH SLIP RING DEVICE, METHOD FOR PRODUCING A ROTOR WITH A SLIP RING DEVICE, AND ELECTRIC MACHINE WITH A ROTOR

(71) Applicant: SCHAEFFLER TECHNOLOGIES AG & CO. KG, Herzogenaurach (DE)

(72) Inventors: Nils Krone, Königs Wusterhausen (DE); Tomislav Marina, Berlin (DE); Nico Daun, Potsdam (DE)

(73) Assignee: Schaeffler Technologies AG & Co. KG, Herzogenaurach (DE)

(21) Appl. No.: 18/992,181

(22) PCT Filed: Jul. 10, 2023
(86) PCT No.: PCT/EP2023/068974

§ 371 Date: Nov. 17, 2025

(30) Foreign Application Priority Data
Jul. 14, 2022 (DE) 10 2022 207 180.8

(51) Int. Cl. H02K 1/22; H02K 7/00; H02K 11/00

(52) U.S. Cl. CPC H02K 1/22; H02K 7/003; H02K 11/0094

(57) ABSTRACT

A rotor for a separately excited electric machine, including an assembled rotor shaft having a cylindrical hollow shaft body, at the respective axial end of which a shaft stub is arranged, wherein the respective shaft stub has a flange section and a shaft section including an outer shell surface, a slip ring device running through the shaft section, including at least one annular first slip ring which protrudes beyond a distal end of the shaft section in the axial direction of the rotor, and a first busbar connected to the first slip ring and running through the shaft section, wherein one end of the first busbar is guided through a first busbar opening formed in the flange section, and is thus led out of an interior of the hollow shaft body.

### CROSS-REFERENCE TO RELATED APPLICATIONS

This application claims priority to PCT Application PCT/EP2023/068974, filed Jul. 10, 2023, which claims priority to German Patent Application No. DE 10 2022 207 180.8, filed Jul. 14, 2022. The disclosures of the above applications are incorporated herein by reference.

### FIELD OF THE INVENTION

The invention relates to a rotor for an electric machine, wherein the rotor has an assembled rotor shaft with a hollow shaft carrier and a shaft stub arranged on the end side, wherein a slip ring device is guided through a shaft section of the shaft stub. The invention also relates to a method for producing the rotor according to the invention. Furthermore, the invention relates to a separately excited electric machine with the rotor according to the invention.

### BACKGROUND OF THE INVENTION

A rotor with a slip ring device is known, for example, from EP 2 816 711 B1, in which the slip ring device is plugged from the outside onto a rotor shaft. A bearing is arranged on the slip ring device in a region of the overmolded electrical conductors. The problem here is that the bearing arrangement in the region of the slip ring arrangement does not provide a fluid-tight seal between the rotor and the rubbing contacts seated on the slip rings. This is detrimental in the case of oil cooling of the rotor, as it is necessary to avoid that the oil of the rotor cooling gets between the rubbing contacts and slip rings.

### SUMMARY OF THE INVENTION

It is an object of the invention to provide a rotor for a separately excited electrical machine, in which the slip ring is arranged in a simple and inexpensive manner and allows a fluid-tight separation between an active part of the rotor and an energization section of the rotor.

The problem is solved by the subject matter of the description below and the drawings, wherein each feature may represent an aspect of the invention, both individually and in combination, unless something to the contrary is explicitly stated in the description.

In a first aspect, the invention relates to a rotor for a separately excited electric machine, including an assembled rotor shaft having a cylindrical hollow shaft body, at the respective axial end of which a shaft stub is arranged, wherein the respective shaft stub has a flange section and a shaft section including an outer shell surface, a slip ring device running through the shaft section, having at least one annular first slip ring which protrudes beyond a distal end of the shaft section in the axial direction of the rotor, and a first busbar connected to the first slip ring and running through the shaft section, wherein one end of the first busbar is guided through a first busbar opening formed in the flange section, and is thus led out of an interior of the hollow shaft body.

In other words, it is provided according to the first aspect of the invention that a rotor is provided for a separately excited electric machine. The electric machine is designed and/or configured to be arranged in a motor vehicle. In an embodiment, the electric machine sits in a drive train of the motor vehicle in order to drive the motor vehicle at least partially electrically.

The rotor has an assembled rotor shaft. The assembled rotor shaft includes a cylindrical hollow shaft body, on which a laminated rotor core is usually arranged. The laminated rotor core, along with a rotor winding arranged on it, may also be referred to as the active part of the rotor. A shaft stub is arranged at the respective axial end of the hollow shaft body. The respective shaft stub includes a flange section and a shaft section. The flange section is designed and/or formed to enter into a connection with the hollow shaft body. The shaft section is designed and/or formed to mount the rotor via at least one bearing device in such a way that it is rotated around a rotor axis of the rotor. To this end, it is provided that the shaft section has an outer shell surface. The outer shell surface is of continuous configuration in the circumferential direction of the rotor or the shaft section, i.e. is uninterrupted.

Furthermore, the rotor includes a slip ring device which runs through the shaft section or through an interior of the shaft section. The slip ring device includes at least one first slip ring of annular configuration, which protrudes beyond a distal end of the shaft section in the axial direction of the rotor. This section of the slip ring device, which protrudes beyond the distal end of the shaft section, may also be referred to as the energization section. The distal end of the shaft section is formed on one side of the shaft section facing away from the hollow shaft body. A first busbar running through the shaft section is electrically conductively connected to the first slip ring. A distal end of the first busbar is guided through a first busbar opening formed in the flange section. Thus, the distal end of the first busbar is led out of an interior of the hollow shaft body. Consequently, the end of the first busbar is electrically conductively connected to a rotor winding of the separately excited rotor. The first slip ring and/or the first busbar are/is each made of an electrically conductive material. The electrically conductive material includes copper and/or is made from copper. In an embodiment, the electrically conductive material is a copper alloy, which at least partially includes bronze.

Due to the fact that the slip ring device runs through the interior of the shaft section, the shaft section may have a continuous shell surface in the circumferential direction of the rotor, on which a bearing device for rotatable mounting of the rotor is arranged. Thus, a fluid-tight or coolant-tight seal between the bearing device and the bearing seat is made possible in this region of the shaft section in a simple manner, with the result that it may be avoided that a coolant, such as an oil, of the rotor passes into the region of the first slip ring. In addition, the slip ring device is easily and inexpensively arranged in the rotor as a result of the internal slip ring device in the shaft section.

One development of the invention lies in the fact that the flange section, the shaft section and/or the hollow shaft body are/is formed from the same material. It is thus conceivable that the flange section and the shaft section are formed from the same material, wherein the hollow shaft body has a different material from the shaft section. However, it is also conceivable that the shaft section and the hollow shaft body are formed from the same material, wherein the flange section has a different material therefrom. In an embodiment, it is provided that both the flange section, the shaft section and the hollow shaft body are formed from the same material. The three components are connected to each other in a simple manner, provided that they are not at least partially formed in one piece with each other. Furthermore, a risk of contact corrosion of the three components is reduced if they are made from the same metallic material.

In an embodiment, it is provided that the shaft section and the shaft flange are formed in one piece. The one-piece design means that the shaft section and the shaft flange are manufactured in a manufacturing process and are connected to each other. This is done, for example, by an additive process, a casting process and/or by a milling process.

In one embodiment of the invention it is provided that the flange section, the shaft section and/or the hollow shaft body are/is formed from a metal and/or include/includes a metallic material. Therefore, the rotor may have the structural rigidity required for the planned life of the rotor using an inexpensive material. In this way, the manufacturing costs of the rotor are reduced.

According to one development of the invention, it is provided that, at one axial end of the hollow shaft body, one of the shaft stubs is formed in one piece with the hollow shaft body. Accordingly, it is provided that the shaft stub is directly already formed in one piece with the hollow shaft body. In other words, it is provided that the hollow shaft body has an opening at a distal end, while, at another distal end of the hollow shaft body, the shaft stub is formed directly, i.e. proximately, with the hollow shaft body in a manufacturing process. Therefore, the number of components is reduced. In turn, this has a beneficial effect on the manufacturing process, which reduces manufacturing costs.

In one embodiment of the invention, it is provided that, at one axial end of the hollow shaft body, the shaft stub is connected to the hollow shaft body in an integrally joined, form-fit and/or force-fit manner. The integrally joined connection may be an adhesive connection and/or a welded connection. The form-fit connection may be a connection in which the flange of the shaft stub interlocks with the hollow shaft body at at least one point. This may be a guide structure having a tongue and groove connection. The force-fit connection may be a screwed and/or riveted connection. It is provided here that the flange is screwed onto the hollow shaft body.

One embodiment of the invention lies in the fact that the slip ring device has an annular second slip ring different from the first slip ring and spaced apart from the first slip ring in the axial direction of the rotor, and a second busbar connected to the second slip ring and running through the shaft section, wherein one end of the second busbar is guided through a second busbar opening formed in the flange section, and is thus led out of the interior of the hollow shaft body. In other words, it is provided that the slip ring device has two electrically conductive slip rings spaced apart from each other and separated from each other, wherein each slip ring is connected to at least one electrically conductive busbar. The first slip ring has at least the first busbar and the second slip ring has at least the second busbar. Both the end of the first busbar and the end of the second busbar are each routed through a corresponding busbar opening in the flange section of the shaft stub. The respective end of the busbars is designed and configured to be electrically conductively connected to the rotor winding of the rotor.

It is conceivable that an outer diameter of the annular first slip ring is equal to an outer diameter of the annular second slip ring. Therefore, the sliding contacts or carbon brushes acting on the first slip ring and the second slip ring may be arranged at the same height. However, the arrangement of the two slip rings side by side and the routing of the two busbars in the slip ring device, in the manufacture of the slip ring device, is somewhat more complex, since the first busbar and the second busbar cannot be routed at the same height, relative to the radial direction of the busbars.

As an alternative to this, one embodiment of the invention lies in the fact that an outer diameter of the annular first slip ring is smaller than an inner diameter of the annular second slip ring. In this context, if the respective busbar extends in the axial direction of the respective slip ring, the first slip ring is guided through the second slip ring, and the first busbar and the second busbar run parallel to each other at least in sections and/or offset with respect to one another in the circumferential direction. This allows the slip rings to be arranged in a simple way. This is especially true for an overmolding process.

One embodiment of the invention lies in the fact that the first slip ring and/or the second slip ring are/is arranged in an electrically insulating slip ring carrier. It goes without saying that at least one outer shell surface of the first slip ring and the second slip ring are exposed, so that they may enter into electrically conductive contact with the rubbing contacts, which are also referred to as carbon brushes. It is provided that not only the slip rings, but also the first busbar and/or the second busbar are arranged in the slip ring carrier. It is provided that these are completely surrounded by or embedded in the insulating slip ring carrier with the exception of the respective distal end portion. Thus, the slip ring device is easily prefabricated and inserted into the shaft section. The possible prefabrication reduces the manufacturing costs.

It is provided that the slip ring carrier terminates in a medium-tight manner with the respective busbar opening in the region of the latter. This prevents coolant from entering the interior of the hollow shaft body via the busbar opening. Likewise, in cooling of the hollow shaft body from the inside, a seal is thus achieved such that the cooling medium does not penetrate outward via the busbar openings.

Fundamentally, the slip ring device is arranged in the shaft section in such a way that it is connected to the shaft section fixedly for conjoint rotation. One embodiment of the invention provides that the slip ring device is arranged in the shaft section in an integrally joined, form-fit and/or force-fit manner. The form-fit arrangement may provide that the shaft portion has a projection on a side facing inward in the radial direction and that the slip ring device has a recess corresponding to the projection on an outer side facing outward in the radial direction, with the result that the projection engages into the recess in the axial direction of the shaft section during insertion of the slip ring device and enters into a form-fit connection with the shaft section. The integrally joined connection is an adhesive connection. The force-fit connection may be a screwed and/or riveted connection.

One development of the invention lies in the fact that a bearing seat is formed on an outer shell surface of the shaft section. In the region of the bearing seat, the outer shell surface of the shaft section is completely closed in the circumferential direction. In addition, based on the radial direction of the shaft section in the region of the bearing seat, a step is formed, which serves in the axial direction of the rotor as a stop for the bearing seat. It is provided that a bearing device is arranged on the bearing seat, with the result that the rotor is rotatably mounted. By way of the configuration of the bearing seat and the arrangement of the bearing device, it may be avoided that a coolant of the rotor, such as an oil, flows in the region of the bearing seat in the direction of the slip rings and comes into contact with them.

In a second aspect, the invention relates to a method for producing the rotor according to the invention, wherein the slip ring device is introduced with the annular first slip ring first via a flange side of the shaft stub into the shaft section, with the result that the first slip ring is guided beyond the distal end of the shaft section, and the end of the first busbar is guided through the first busbar opening of the flange section.

The end of the first busbar is thus formed on one side of the busbar facing away from the slip ring. In an embodiment, the end of the first busbar is deflected such that it is directed in the direction of the first slip ring, or is oriented parallel to the longitudinal direction of the first slip ring. In this way, the slip ring device is introduced co-axially with respect to the shaft section via a translational movement into the shaft section, wherein the first slip ring protrudes beyond the distal end of the shaft section and the end of the first busbar is guided through the busbar opening in the flange section. Thus, the slip ring device is arranged in a simple and inexpensive way in the rotor. Due to the fact that the slip ring device is designed to lie on the inside, a bearing device for rotatable mounting of the rotor is arranged on the shaft section. The shaft section or an outer shell surface is formed continuously in the region of the bearing device, with the result that it is prevented that, in the region of the rotor bearing, a cooling medium of the rotor passes in the direction of the first slip ring.

In one embodiment of the invention, it is provided that the shaft stub and the hollow shaft body are connected to each other in an integrally joined, form-fit and/or force-fit manner after the arrangement of the slip ring device in the shaft stub. The integrally joined connection is an adhesive connection or a welded connection. The form-fit connection is a tongue-and-groove connection. The force-fit connection is a screwed and/or riveted connection.

One embodiment of the invention provides that the slip ring device is arranged in the shaft section in an integrally joined, form-fit and/or force-fit manner. The form-fit arrangement provides that the shaft portion has a projection on a side facing inward in the radial direction and that the slip ring device has a recess corresponding to the projection on an outer side facing outward in the radial direction, with the result that the projection engages into the recess in the axial direction of the shaft section during insertion of the slip ring device and enters into a form-fit connection with the shaft section. The integrally joined connection is an adhesive connection. The force-fit connection may be a screwed and/or riveted connection.

The slip ring device, having the first slip ring and the first busbar, is arranged in the slip ring carrier by overmolding. In an embodiment, the first slip ring, the first busbar, the second slip ring and the second busbar are arranged in the slip ring carrier by overmolding. In this way, a slip ring device is provided, which is prefabricated and easily arranged in the shaft stub. Thus, the manufacturing costs are reduced.

In a third aspect, the invention relates to a separately excited electric machine with the rotor according to the invention.

The electric machine is a constituent part of a traction drive for driving a motor vehicle at least partially, or completely, electrically.

It should be noted that all the features described above and below in relation to one aspect of the present invention apply equally to any other aspect of the present invention. All the characteristics of the rotor may also be characteristics of the method and/or the electric machine. This is also the case vice versa.

Further features of the present invention result from the following embodiments. The embodiments are not limiting, but rather to be understood as exemplary. They are intended to enable the person skilled in the art to carry out the invention. The applicant reserves the right to make individual features and/or a plurality of the features disclosed in the embodiments.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The exemplary embodiments will be explained in more detail using drawings, in which:

FIG. 1 shows a detail of a three-dimensional view of a rotor in the region of a shaft stub with a slip ring device;

FIG. 2 shows an exploded view of the rotor; and

FIG. 3 shows a sectional illustration through the shaft stub and the slip ring device.

### DETAILED DESCRIPTION OF THE PREFERRED EMBODIMENTS

The following description of the preferred embodiment(s) is merely exemplary in nature and is in no way intended to limit the invention, its application, or uses.

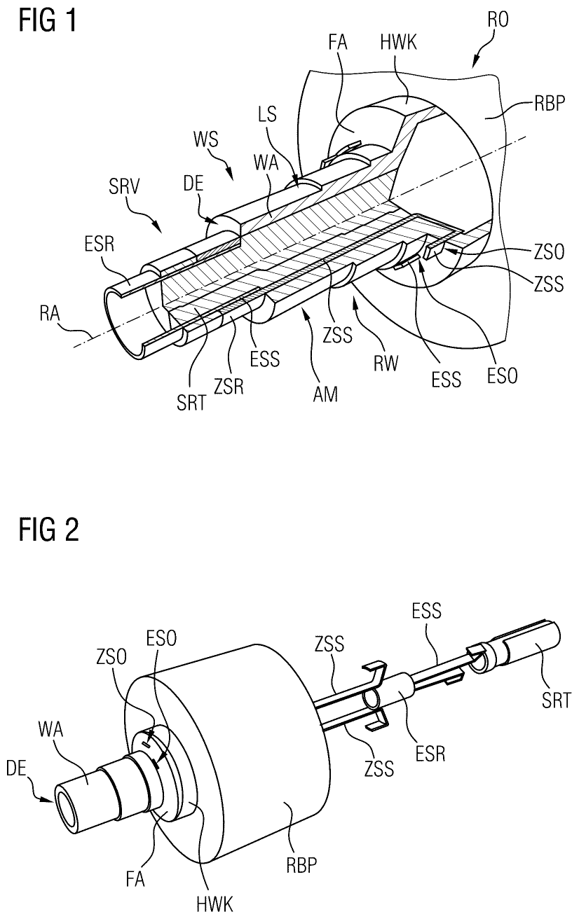

FIG. 1 shows a detail of a three-dimensional view of a rotor RO in the region of a shaft stub WS with a slip ring device SRV. The rotor RO has an assembled rotor shaft RW. The assembled rotor shaft RW includes a cylindrical hollow shaft body HWK, on which a laminated rotor core RBP is arranged fixedly for conjoint rotation. The shaft stub WS is arranged at the respective axial end of the hollow shaft body HWK. The respective shaft stub WS includes a flange section FA and a shaft section WA. The flange section FA is fixed to the hollow shaft body HWK fixedly for conjoint rotation. The shaft section WA is designed and/or configured to mount the rotor RO via at least one bearing device LER such that it may be rotated around a rotor axis RA of the rotor RO. To this end, it is provided that the shaft section WA has an outer shell surface AM. The outer shell surface AM is formed continuously in the circumferential direction of the rotor RO or the shaft section WA, i.e. uninterruptedly or continuously annularly.

The slip ring device SRV runs through the shaft section WA and includes an annular first slip ring ESR and an annular second slip ring ZSR. Both the first slip ring ESR and the second slip ring ZSR protrude at least in sections beyond a distal end DE of the shaft section WA relative to the axial direction of the rotor RO. The distal end DE of the shaft section WA is formed on one side of the shaft section WA facing away from the hollow shaft body HWK. A first busbar ESS running through the shaft section WA is electrically conductively connected to the first slip ring ESR. A second busbar ZSS is also electrically conductively contacted with the second slip ring ZSR. A distal end of the first busbar ESS is guided through a first busbar opening ESO formed in the flange section FA of the shaft stub WS. Likewise, a distal end of the second busbar ZSS is guided through a second busbar opening ZSO formed in the flange section FA of the shaft stub WS. Thus, the distal end of the first busbar ESO and the distal end of the second busbar ZSS are led out of an interior of the hollow shaft body HWK. Consequently, the end of the first busbar ESS and the end of the second busbar ZSS may be electrically conductively connected to a rotor winding (not shown) of the separately excited rotor RO.

The first slip ring ESR, the second slip ring ZSR, the first busbar ESS and the second busbar ZSS are each made from an electrically conductive material. The electrically conductive material is copper and/or is made from copper. It is conceivable that the first busbar ESS is arranged in an integrally joined manner with respect to the first slip ring ESR and/or the second busbar ZSS is arranged in an integrally joined manner with respect to the second slip ring ZSR. The integrally joined connection is a soldered or welded connection. However, it is also conceivable that the first busbar ESS and the first slip ring ESR and/or the second busbar ZSS and the second slip ring ZSR are formed in one piece together.

Due to the fact that the slip ring device SRV runs through the interior of the shaft section WA, the shaft section WA in the present exemplary embodiment has a continuous outer shell surface AM in the circumferential direction of the rotor RO in the region of a bearing seat LS, on which a bearing device LER is arranged for rotatable mounting of the rotor RO. Thus, in this region of the shaft section WA, a fluid-tight or coolant-tight seal is made possible in a simple manner in the region of the bearing seat LS, with the result it may be avoided that a coolant, such as an oil, of the rotor RO may pass into the region of the slip rings ESR, ZSR.

Furthermore, the first slip ring ESR, the first busbar ESS, the second slip ring ZSR and the second busbar ZSS are arranged in a slip ring carrier SRT by overmolding. In other words, the first slip ring ESR and the first busbar ESS, the second slip ring ZSR and the second busbar ZSS are arranged in the slip ring carrier or held by it. The first slip ring ESR and the second slip ring are galvanically separated from each other in the slip ring carrier SRT and are arranged spaced apart from each other in the axial direction of the rotor RO. An outer shell surface of the first slip ring ESR and an outer shell surface of the second slip ring ZSR are exposed so that they enter into electrically conductive contact with the rubbing contacts or carbon brushes (not shown). By the arrangement of the slip rings ESR, ZSR in the slip ring carrier SRT, a slip ring device SRV is provided, which may be prefabricated and easily arranged in the shaft stub WS. Thus, the manufacturing costs are reduced.

As shown in FIG. 1 and FIG. 2, an outer diameter of the annular first slip ring ESR is smaller than an inner diameter of the annular second slip ring ZSR. In this context, if the respective busbar ESS, ZSS connected to the slip ring ESR, ZSR extends in the axial direction of the respective slip ring ESR, ZSR, the first slip ring ESR is guided through the second slip ring ZSR, and the first busbar ESS and the second busbar ZSS run parallel and/or offset in the circumferential direction with respect to each other at least in sections. Thus, the first slip ring ESR and the second slip ring ZSR may be arranged in a simple manner with respect to each other prior to overmolding by a plastic material for forming the slip ring carrier SRT.

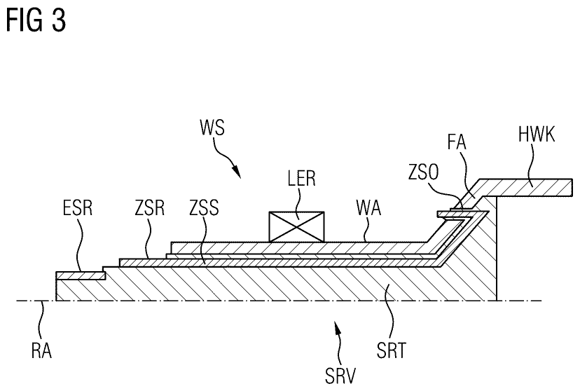

FIG. 3 shows a sectional illustration through the shaft stub WS and the slip ring device SRV. The end of the second busbar ZSS is formed on a side of the second busbar ZSS facing away from the second slip ring ZSR, wherein the end of the second busbar ZSS is deflected such that it is directed in the direction of the second slip ring ZSR, or is oriented parallel to the longitudinal direction of the second slip ring ZSR. The first busbar ESS is designed in the same way. Thus, the slip ring device SRV may be introduced co-axially with respect to the shaft section WA via a translational movement into the shaft section WA, wherein the first slip ring ESR and the second slip ring ZSR protrude beyond the distal end DE of the shaft section WA, and the end of the first busbar ESS is guided through the first busbar opening ESO in the flange section FA and the end of the second busbar ZSS is guided through the second busbar opening ZSO. The slip ring device SRV is thus arranged in a simple and inexpensive manner in the rotor RO. Due to the fact that the slip ring device SRV is designed to lie on the inside, the bearing device LER arranged on the shaft section WA for the rotatable bearing of the rotor RO enables a fluid-tight seal to the shaft section WA, with the result that in this region a coolant, such as an oil, from the region of the rotor RO does not reach the slip rings ESR, ZSR.

The slip ring carrier SRT terminates in a medium-tight manner in the region of the first busbar opening ESO and/or in the region of the second busbar opening ZSO. Thus, it may be avoided that a coolant penetrates the hollow shaft body HWK via the first busbar opening ESO and/or the second busbar opening ZSO.

The description of the invention is merely exemplary in nature and, thus, variations that do not depart from the gist of the invention are intended to be within the scope of the invention. Such variations are not to be regarded as a departure from the spirit and scope of the invention.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

16. (canceled)

17. A rotor for a separately excited electric machine, comprising:
an assembled rotor shaft, further comprising:
a cylindrical hollow shaft body;
a shaft stub arranged at the axial end of the cylindrical hollow shaft body, the shaft stub further comprising:
a flange section having a first busbar opening;
a shaft section having an outer shell surface;
a slip ring device running through the shaft section, the slip ring device further comprising:
at least one annular first slip ring which protrudes beyond a distal end of the shaft section in the axial direction of the rotor; and
a first busbar connected to the at least one annular first slip ring and running through the shaft section;
wherein one end of the first busbar is guided through the first busbar opening and is thus led out of an interior of the hollow shaft body.

18. The rotor of claim 17, wherein the flange section, the shaft section and/or the hollow shaft body are/is formed from the same material.

19. The rotor of claim 17, wherein the flange section, the shaft section and/or the hollow shaft body are/is formed from a metal and/or comprise/comprises a metallic material.

20. The rotor of claim 17, wherein, at one axial end of the hollow shaft body, one of the shaft stubs is formed in one piece with the hollow shaft body.

21. The rotor of claim 17, wherein, at one axial end of the hollow shaft body, the shaft stub is connected to the hollow shaft body in an integrally joined, form-fit and/or force-fit manner.

22. The rotor of claim 17, the slip ring device further comprising:
an annular second slip ring spaced apart from the first slip ring in the axial direction of the rotor;
a second busbar connected to the second slip ring and running through the shaft section; and
a second busbar opening formed in the flange section;
wherein one end of the second busbar is guided through the second busbar opening and is thus led out of the interior of the hollow shaft body.

23. The rotor of claim 22, wherein an outer diameter of the annular first slip ring is smaller than an inner diameter of the annular second slip ring.

24. The rotor of claim 22, further comprising:
an electrically insulating slip ring carrier;
wherein the first slip ring and/or the second slip ring are/is arranged in the electrically insulating slip ring carrier.

25. The rotor of claim 24, wherein the electrically insulating slip ring carrier terminates in a medium-tight manner in the region of the first busbar opening and/or the region of the second busbar opening.

26. The rotor of one of claim 17, further comprising a bearing seat formed on an outer shell surface of the shaft section.

27. The rotor of claim 17, wherein the slip ring device is arranged in the shaft section in an integrally joined, form-fit and/or force-fit manner.

28. A method for producing a rotor of claim 17, comprising the step of introducing the slip ring device with the annular first slip ring first via a flange side of the shaft stub into the shaft section, such that the first slip ring is guided beyond the distal end of the shaft section, and the end of the first busbar is guided through the first busbar opening of the flange section.

29. The method of claim 28, wherein the shaft stub and the hollow shaft body are connected to each other in an integrally joined, form-fit and/or force-fit manner after the arrangement of the slip ring device in the shaft stub.

30. The method of claim 28, wherein the slip ring device is arranged in the shaft section in an integrally joined, form-fit and/or force-fit manner.

31. The method of one of claim 28, wherein the first slip ring, the first busbar, the second slip ring and the second busbar are arranged in the slip ring carrier by overmolding.

32. An electric machine with a rotor of one of claim 17.
